(19) United States
(12) Patent Application Publication
(10) Pub. No.: US 2007/0245280 A1
(43) Pub. Date: Oct. 18, 2007

(54) SYSTEM AND METHOD FOR PLACEMENT OF SOFT MACROS

(75) Inventors: Cornells Van Eijk, Hilvarenbeek (NL); Michail Romesis, Eindhoven (NL); Roger Carpenter, Palo Alto, CA (US); Philippe Sarrazin, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Magma Design Automation, Inc., Santa Clara, CA (US)

(21) Appl. No.: 11/734,717

(22) Filed: Apr. 12, 2007

Related U.S. Application Data
(60) Provisional application No. 60/792,164, filed on Apr. 14, 2006.

(51) Int. Cl. G06F 17/50; G06F 9/45

(52) U.S. Cl. 716/9

(57) ABSTRACT

An electronic design automation method of placing circuit components of an integrated circuit (“IC”) is provided. A synthesized circuit netlist including one or more soft macros is received and a rough global placement of this netlist is performed. A shaper function is determined. The shaper function evaluates a cost of a current placement of the one or more soft macros based on one or more constraints and one or more penalty functions which are associated with the one or more constraints. Moreover, the current placement is optimized to produce a subsequent placement of the one or more soft macros by minimizing the cost. Furthermore, where the netlist includes one or more hard macros, a legalization requirement is applied to the one or more hard macros.

### CROSS-REFERENCES TO RELATED APPLICATIONS

This application claims priority from provisional patent application 60/792,164, entitled, “A Method For Combining Global Placement Macro-Shaping With Macro-Legalization,” filed Apr. 14, 2006, which is incorporated by reference herein.

### BACKGROUND OF THE INVENTION

The present invention relates generally to the field of semiconductor chip design and more specifically to a system and method for placement of soft macros.

Semiconductor chips are vastly complex structures. Accordingly, chip design requires significant effort. The total amount of time required to design a chip has been radically reduced through the use of design modules or the re-use of previously designed modules during the digital layout or placement phase of chip design. Design modules are reusable portions of a chip design and may be supplied by vendors of electronic design automation tools. Circuit components during placement include one or more of standard cells, macro blocks, and I/O pads. A macro block indicates a circuit block or a function block which has a higher function and/or larger scale than a basic standard cell. The design modules appear as macro blocks (herein, “macro”) in one of two forms: as hard macros or as soft macros.

Hard macros have predefined layouts with fixed aspect ratios and clearly specified internal shapes. More specifically, hard macros refer to specific standard cells that are registered in the layout library and that can be laid out directly from a netlist. An example of a hard macro is an embedded memory. All of the layout and shapes of the memory are defined in a layout library. Using the library, the memory is placed on the chip and the inputs and outputs of the memory are subsequently wired to the remainder of the chip logic. Hard macros must be placed on a chip as-is and then wired to the remainder of the chip.

Soft macros are not registered in the layout library. Rather, at the logical level, soft macros typically take the form of Register Transfer Level (RTL) portions implemented in High level Design Language (HDL). HDL is typically either Verilog or VHDL netlists which are imported into the design. The soft macros are then synthesized and implemented in layout structures during the chip design. Because the soft macros are not registered in the layout library, in order to be laid out, the soft macros are each developed as a plurality of smaller hard macros and/or individual standard cells which implement the functions of the soft macro. It is necessary to use the layout library for the developed hard macros and standard cells. The standard cells provide the base functionality such as NAND, NOR, and other basic logic blocks. By connecting the smaller hard macros and standard cells together, the logic function of the soft macro is implemented.

Each microelectronic circuit device or cell includes a plurality of pins or terminals, each of which is connected to pins or terminals of other devices or cells by a respective electrical interconnection wire network, or net. Historically, during optimization of digital layout, the objectives of layout have been to determine a cell placement such that all of the required interconnections can be made while minimizing wire length, timing slack, interconnection congestion, and power consumption. Moreover, a further objective has been to provide a near-ideal layout that incorporates fast circuit paths in a small layout area.

Typical methods for achieving these objectives include constructive placement algorithms and iterative improvement algorithms. Iterative improvement algorithms start with one or more initial placements. These algorithms modify the one or more initial placements using optimization methodologies in search of a better placement. The algorithms are applied in a recursive or an iterative manner until no further improvement is possible, or the placement is considered to be satisfactory based on certain predetermined criteria, such as if a valid placement has been found.

However, prior methods have been unsuccessful at providing satisfactory layout and optimization solutions. The combination of larger hard macros, soft macros, and smaller hard macros within soft macros makes optimization in the chip design exceedingly complex. The layout configuration of the hard macros and soft macros using the known iterative methods typically results in a non-optimal arrangement because of the limited optimization constraints available. For example, layout configuration may be optimized through each iteration by allowing a chip designer or electronic design automation software to select a specific placement of the hard macro. Additional optimization may allow for the selection of a directional orientation of the hard macro. Moreover, in many implementations, the digital layout is optimized to pack the layout objects as tightly together as possible without adequate consideration of the need for efficient communication between the objects through high-speed interconnect. These methods do not provide the most optimal layout configurations.

### BRIEF SUMMARY OF THE INVENTION

Techniques for a system and method for placement of soft macros is described herein. The combination of larger hard macros, soft macros, and smaller hard macros within soft macros makes optimization in the chip design exceedingly complex.

In accordance with an embodiment of the invention, an electronic design automation method of placing circuit components of an integrated circuit (“IC”) includes the following steps. A synthesized circuit netlist comprising one or more soft macros is received and a rough global placement of this netlist is performed. A shaper function is determined. The shaper function evaluates a cost of a current placement of the one or more soft macros based on one or more constraints and one or more penalty functions which are associated with the one or more constraints. Moreover, the current placement is optimized to produce a subsequent placement of the one or more soft macros by minimizing the cost. Furthermore, where the netlist includes one or more hard macros, a legalization requirement is applied to the one or more hard macros.

In one embodiment, the shaper function is based on a utilization constraint whereby a target utilization corresponding to each soft macro is determined. The target utilization represents a target density of soft macro components with the soft macros. For this constraint, the shaper function calculates a utilization ratio by determining a difference between a current utilization of a current soft macro and the corresponding target utilization. In the event the difference satisfies a threshold, the utilization ratio is normalized. A utilization penalty is calculated. In another embodiment, the shaper function is based on a shape deviation constraint and a target outline corresponding to each soft macro is constructed. For this constraint, the shaper function calculates a difference between a shape of a current soft macro and the corresponding target outline. In the event the difference satisfies a threshold, a shape deviation penalty is calculated. In yet another embodiment, the shaper function is based on a perimeter constraint where the shaper function calculates a ratio of a perimeter of a current soft macro to a perimeter of a bounding box. In the event the ratio satisfies a threshold, a perimeter penalty is calculated.

In one embodiment, the shaper function is based on an area constraint where the shaper function calculates a ratio of an area of a bounding box to an area of a current soft macro and in the event the ratio satisfies a threshold, calculates an area penalty. Furthermore, where the shaper function is based on the aspect constraint the shaper function calculates an aspect ratio based on a bounding box and an area of a current soft macro. An aspect penalty may then be calculated. In one embodiment, the shaper function is based on a displacement constraint where the shaper function calculates a difference between a rough global placement of a soft macro of the one or more soft macros and a current placement of the soft macro and may calculate a displacement penalty. Where the shaper function is based on a coverage constraint, the shaper function may determine an overlap shape between a shape of a current soft macro and a shape of a subsequent soft macro and may calculate a coverage penalty. In one embodiment, the shaper function is based on a grid constraint where the shaper function calculates a difference between a current alignment of a soft macro on a grid to a target grid location and may calculate a grid penalty. In another embodiment, the shaper function is based on a relative constraint where the shaper function calculates a distance between a current placement of a first circuit component and a current placement of a second circuit component; and may calculate a relative penalty. In another embodiment, the shaper function is based on a repeated block constraint where the shaper function calculates a difference between a shape of a first instance of a soft macro and a shape of a second instance of the soft macro and may calculate a repeated block penalty.

### BRIEF DESCRIPTION OF THE DRAWINGS

The invention may best be understood by reference to the following description taken in conjunction with the accompanying drawings in which:

FIG. 1A is a process flow diagram which illustrates one method for placement and optimization of hard macros and soft macros, in accordance with an embodiment of the present invention.

FIG. 1B is a process flow diagram which illustrates one method of measuring a cost of a placement configuration, in accordance with an embodiment of the invention.

FIG. 2A is a diagrammatic representation of a possible soft macro configuration.

FIG. 2B is a diagrammatic representation of an invalid soft macro outline.

FIG. 2C is a diagrammatic representation of a valid soft macro outline.

FIG. 2D is a diagrammatic representation of an optimal soft macro configuration.

FIG. 2E is a diagrammatic representation of a soft macro configuration with an L-shaped outline.

FIG. 2F is another diagrammatic representation of a possible soft macro configuration.

FIG. 3A is a diagrammatic representation of a notch-shaped soft macro and an accompanying bounding box.

FIG. 3B is a diagrammatic representation of an L-shaped soft macro and an accompanying bounding box.

FIG. 4A is a diagrammatic representation of an L-shaped soft macro.

FIG. 4B is a diagrammatic representation of a soft macro having a non-simple shape.

FIG. 4C is a diagrammatic representation of an invalid soft macro configuration.

FIG. 4D is a diagrammatic representation of another invalid soft macro configuration.

FIG. 5A is a diagrammatic representation of a chip design with standard cells and hard macros after rough global placement.

FIG. 5B is a diagrammatic representation of a chip design with soft macros outlines for the standard cells and hard macros included in the soft macros after final placement.

FIG. 6A is a graphic representation of a linear growth penalty function applied during optimization of a constraint.

FIG. 6B is a graphic representation of an exponential growth penalty function applied during optimization of a constraint.

FIG. 7A is a diagrammatic representation of standard cells included in soft macros after rough global placement.

FIG. 7B is a diagrammatic representation of soft macro outlines for the standard cells included in the soft macros after final placement.

FIG. 8 illustrates an exemplary computer system 800, in which various embodiments of the present invention may be implemented.

### DETAILED DESCRIPTION OF THE INVENTION

During the physical design flow, placement assigns exact locations for various circuit components within the chip area. An inferior placement assignment may affect a chip's performance. In one embodiment, placement of both hard and soft macros are optimized to improve the chip wireability and to enhance the performance characteristics of the design.

To begin digital layout of the chip design process, an input netlist (e.g., a logic gate-level netlist synthesized from a behavioral description of an integrated circuit or a portion of an integrated circuit) including macros and standard cells is received. Hard macros and/or standard cells are grouped into soft macros. A top level design is provided which includes all of the components of the netlist at the highest level of hierarchy. The top level design includes soft macros and may also include top-level hard macros and standard cells for implementing glue logic. In addition, a floorplan is provided which defines the total area available for the chip design. All of these components make up the design and may be used for design layout. Design layout tasks include a number of tasks performed iteratively, including the steps of circuit partitioning, placement and routing.

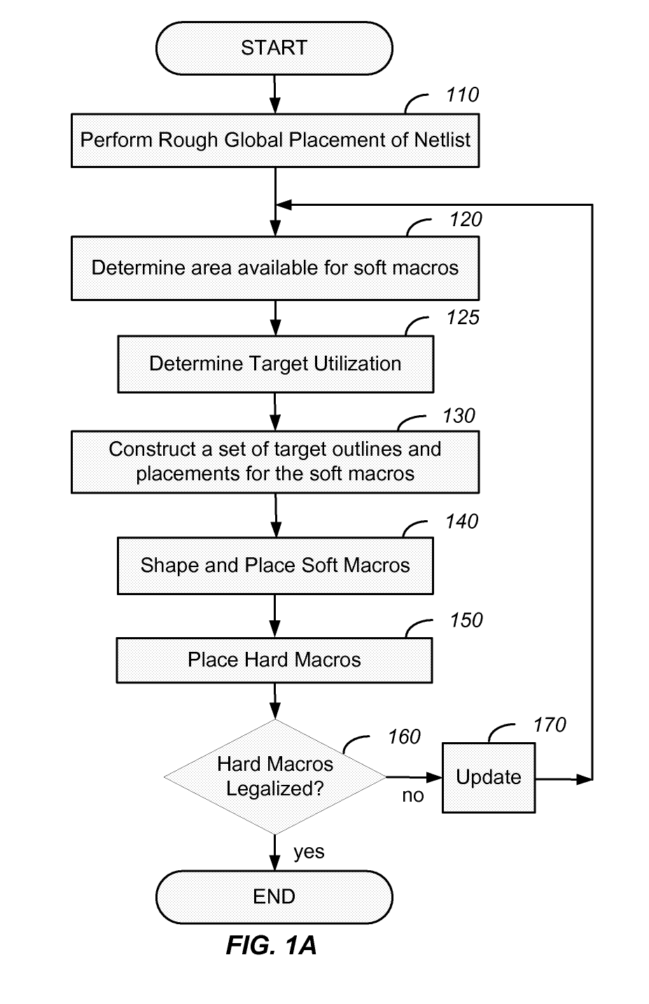

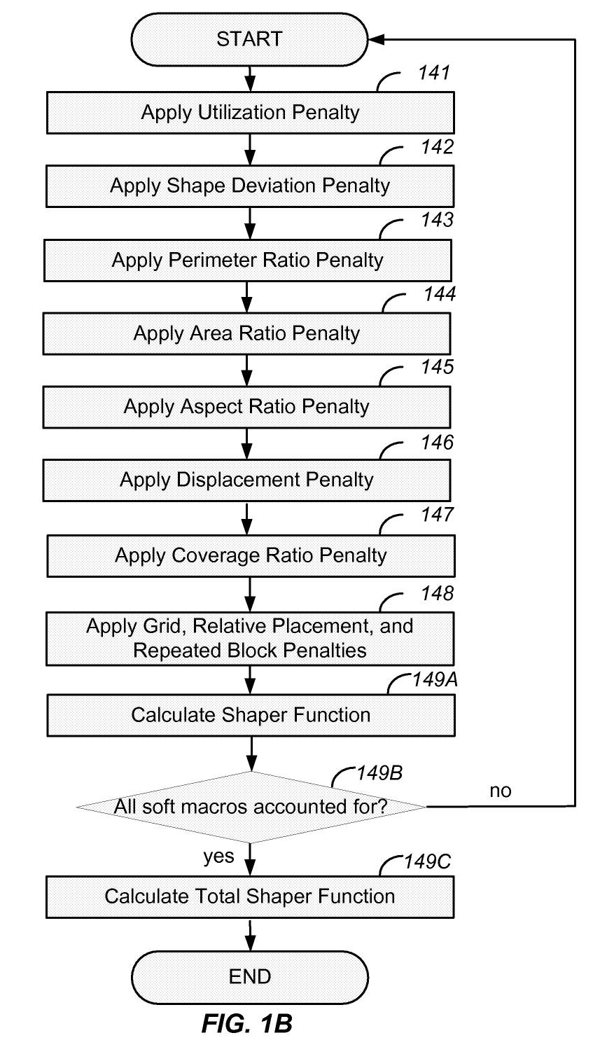

FIG. 1A is a process flow diagram which illustrates one method for placement and optimization of hard macros and soft macros in accordance with an embodiment of the present invention. In one embodiment, the optimization of the placement assignments and shapes for soft macros is described using a shaper function. The shaper function represents an overall cost of the current placement configuration for a soft macro. An optimization process is used to modify the shape and placement configuration of the macros to improve the cost of the configuration. The cost is computed by a shaper function which optimizes the soft macro configuration based on one or more constraints and corresponding penalties. Thus, optimizations are performed by minimizing the cost associated with the shaper function. In one embodiment, the shaper function is determined in parallel and/or sequential progression for each soft macro to be optimized.

Rough global placement of the netlist is performed at step 110 for the chip design. The goal of global placement is to locate a well-spread first placement for the given netlist, including the macros and standard cells, while optimizing for wireability, power, performance, and other design characteristics. The macros and cells are allowed to overlap at this stage. The blocks being allowed to overlap indicate that the blocks have not been “legalized” during detailed placement. A placement requirement may be specified in which the standard cells of a single soft macro be placed adjacent to one another such as in a contiguous group. This requirement prevents hard macros and/or standard cells incorporated within a single soft macro from being placed at a far distance from one another.

The area available for each soft macro is determined at step 120. The area available for a subsequent placement of the soft macros is determined. In one embodiment, the total area available to place the soft macros is the total layout area of the chip, as stated in the floorplan. In an alternative embodiment, hard macros and/or standard cells may be placed in a fixed location of the layout area. Accordingly, the soft macros are placed around the fixed placements. In one embodiment, the area available for each soft macro is determined by the area remaining from the total layout area minus the area occupied by the fixed placements.

The target utilization for each soft macro is determined at step 125. As used herein, target utilization represents the density of hard macros and/or cells within a soft macro. In certain cases which are known to those skilled in the art, performance of a chip is enhanced by optimizing the density of a soft macro. A soft macro may be tightly-packed, having a high density, because of proximity restrictions. Moreover, a soft macro with a limited need for cross wiring may lend itself to a high target utilization in order to preserve floorspace on a chip. Other soft macros may require a lower target utilization in order to improve routability, for example. Target utilization may be based on any one or combination of row utilization, total utilization, and user-defined utilization which are described in more detail below. A soft macro shaping is acceptable, with regard to this constraint, when the shaping of the soft macro results in a predetermined level of target utilization for each of the soft macros in the circuit design.

Target utilization may be determined based on a row utilization ratio. In prior methods, the row utilization represents the density of cells on every row of the chip in the context of partitioning a layout area. As described herein, row utilization is used for shaping and placement of soft macros. Row utilization is determined by first discarding the area occupied by hard macros. The area occupied by all of the standard cells divided by the area of the available rows on the chip, produces the row utilization ratio. This predetermined level of target utilization (e.g., row utilization ratio) is used by the system to shape and place the soft macro. For example, if a soft macro's target utilization rate is fifty percent, then the cells of the soft macro should be placed on the chip space such that the cells actually occupy fifty percent of the space provided for the soft macro on the chip, once the hard macro area has been subtracted. That is, the cells of the soft macro are placed on the chip such that the ratio between the actual amount of the soft macro area occupied by the cells divided by the total area reserved for the soft macro is fifty percent.

The target utilization ratio may be determined based on total utilization. A total utilization cost function may require uniform space utilization over the entire floorplan. The total utilization ratio is the overall area occupied by the combined hard macros and standard cells to the total layout area available, as previously described. This total utilization ratio is used by the system as the target utilization to shape and place the soft macro. For example, the target utilization may require that each soft macro utilize seventy percent of its assigned area. Accordingly, the soft macro is sized such that the components of the soft macro occupy the target utilization rate of the soft macro.

In an alternative embodiment, target utilization is defined by the user and can vary from one soft macro to another. The user-defined target utilization ratios may require that each soft macro meet a predetermined level of utilization of the area assigned to the soft macro. For instance, a first target utilization may require soft macro A to utilize seventy percent of its assigned area. A second target utilization ratio may require soft macro B to utilize eighty percent of its assigned area. It should be recognized that the target utilization may be determined using any one of the preceding methods, any combination thereof, or other means known by those skilled in the art.

In one embodiment, target utilization need not be performed. For example, where a utilization penalty is not included in a shaper function to optimize a soft macro, step 125 may be omitted. In one embodiment, steps 120 and 125 may be performed in any order.

At step 130, a set of target outlines and placements are constructed for each soft macro. The soft macro target outlines are optimized to match the global placement of the hard macros and soft macros incorporated in a soft macro while matching the basic constraints for the shape of the soft macro. In other words, the target outlines are constructed in isolation, without considering whether the target outlines fit well with the shapes of the other soft macros.

The target outlines of the soft macros allow the smaller hard macros inside the soft macros to be legally placed within the soft macro outline. The smaller hard macro placements closely match the desired location, based on the global placement. Generally, the global placer places the hard macros in an acceptable location and a subsequent placement which varies greatly from the rough global placement may not be ideal. The soft macro target outlines may not be used as a final shaping solution. For example, the soft macro target outlines may overlap or may violate other constraints. Regardless, the soft macro target outlines are useful indications of the desired final solution, and are taken into consideration during the shape and placement process at step 140. More specifically, final soft macro shapes that are not similar to any of their corresponding target outlines will be penalized in the overall optimization equation, as will be described.

In one embodiment, one constraint that is optimized during construction of the set of target outlines is shape. The shape constraint prefers that the shape of the soft macro outline be a simple shape. A simple shape is utilized to make the soft macro placement easier and to reduce the placement complexity. A simple shape is one which has a number of sides less than or equal to a threshold, where the threshold is a positive integer. In one embodiment, the threshold is six. A simple shape may also be defined as one in which the angles are 90 degrees. For example, the simplest of shapes is a rectangle, such as a square. The rectangle is a simple shape including four sides, which is less than the threshold of six, with 90 degree internal angles. A slightly more complex version of a simple shape may include an “L” arrangement, which includes six sides with 90 degree angles. Other shapes may allow adequate placement but the simpler shapes are considered better.

The target outlines of the soft macros may be used in the shape and placement step 140. For example, the soft macro target outlines may be compared against a current placement, where the current placement is penalized under the shaper function for deviations from the target outlines. As described herein, a global placement is a placement of the components of a netlist. A current placement or a current soft macro is one which has not been optimized within an iteration level of the iterative process of FIG. 1A. Accordingly, within a first iteration of the recursive process, the global placement is equivalent to the current placement. A subsequent placement or a subsequent soft macro is one which has been optimized within the iteration of the recursive process. In one embodiment, target outlines need not be constructed. For example, where a shape deviation penalty is not included in a shaper function to optimize a soft macro, step 130 may be omitted.

At step 140, soft macros are shaped and placed. Each soft macro outline can take many forms of shapes and sizes. Constraints may be placed on the soft macros to more clearly define the objective outcome based on user selection and/or system selections. These constraints are mapped to an optimization equation. Violation of the constraints results in penalties.

Shaping and placement may begin by the system determining a shaper function based on one or more constraints. A placer program optimizes a current placement based on constraints by minimizing an associated cost with the constraints. In other words, the placer changes cell or macro locations in a current placement to determine a subsequent placement with minimized cost. In essence, the shaper function, a cost measurement, optimizes a current placement by enforcing constraints. Constraints are not hard requirements but are rather points of optimization. If a constraint is not met, a violation is said to occur. When a violation occurs, a penalty function is applied. In one embodiment, the penalty function can be linear or any other increasing function. In one embodiment, the farther away the constraint is from being met, the larger the penalty result. The penalty function may be pre-determined and constant through all optimizations. In an alternative embodiment, the penalty function may vary based on the number of iterations which have been performed. Another alternative embodiment allows for the user to define the penalty function desired. For a completed placement, the penalty functions are summed and the resulting value is used in the optimization. Optimization through the shaper function may be based on the global placement from step 110 and possibly the area available from step 120 and/or the utilization determination from step 125 and/or the target outlines of step 130. The constraints and corresponding penalties which may be applied to the soft macro are described with regard to FIG. 1B.

FIG. 1B is a process flow diagram which illustrates one method of measuring a cost of a placement configuration, in accordance with an embodiment of the invention. It should be noted that any constraint described herein may be applied individually or in any combination with each other or other constraints not mentioned herein. The shaper function may be applied to any number of soft macros within the circuit design. It should also be noted that the constraints, while shown in one particular order, can be performed in any order.

As depicted by step 141, the shaper function may include a utilization penalty. The soft macro placement may be optimized to keep a current utilization near the target utilization described at step 125. In one embodiment, a current utilization of a soft macro is optimized to have a lower value than its corresponding target utilization. To accomplish this, a utilization violation ratio is defined as the current utilization minus the target utilization. When the result is a positive number, the current utilization is higher than the target utilization. For example, if the target utilization is predetermined in step 125 to be 50%, and the current utilization of the soft macro area is calculated to be 80%, a utilization violation is factored into the shaper function for the excess 30% in current utilization. This result comprises a utilization violation ratio. Where the violation satisfies a threshold, the utilization violation ratio is multiplied by penalty_{utilization} which is a normalization term, and the product is an argument to a penalty function a 1, as set forth below:
shaper_function=a₁(penalty_{utilization}*utilization_ratio)

As previously mentioned, target utilization may not be determined, for example, where the utilization penalty is not included in the shaper function. It should be noted that the constraints described herein may be implemented as values, ratios, or other known methods.

As depicted by step 142, the shaper function may include a shape deviation penalty. A soft macro shape deviation penalty may be applied in the overall optimization equation (e.g., shaper function) where a current soft macro shape is compared to its corresponding target outline. The penalty is applied where the current soft macro shape is not similar to any of its corresponding target outlines. For example, the target outlines of a soft macro, as determined in step 130, are compared to the current shape of the soft macro. Where the current shape deviates from the target outlines and this deviation satisfies a threshold, a shape deviation penalty is factored into the overall optimization equation. The shape deviation is an argument to a penalty function a 2, as set forth below:
shaper_function=a₁(penalty_{utilization}*utilization_ratio)+a₂ (target_shape_deviation)

As depicted by step 143, the shaper function may include a perimeter ratio penalty. The penalty is determined as the ratio of the perimeter of the current soft macro to the perimeter of a bounding box. A bounding box is the smallest rectangle that contains all the components of a soft macro. Where the ratio satisfies a threshold, the penalty may be enforced. For example, if the current soft macro is a simple shape, such as a square or rectangle, the ratio of the perimeter of the placed soft macro to the perimeter of the corresponding bounding box may be 1.0. For a highly convoluted soft macro shape with a large perimeter, the resulting ratio may be considerably higher than 1.0. The resulting ratio value is an argument to a penalty function a₃ and is used as a part of the optimization equation, as set forth below:
shaper_function=a₁(penalty_{utilization}*utilization_ratio)+a₂ (target_shape_deviation)+a₃ (perimeter_ratio)

As depicted by step 144, the shaper function may include an area ratio penalty. The penalty is determined as the ratio of the area of the bounding box to the area of the corresponding current soft macro. Accordingly, the penalty is factored into the shaper function for shaping a soft macro where the ratio of the area of the bounding box and the area of the placed soft macro satisfies a threshold. For example, if a placed soft macro occupies an area of a simple shape, such as a square or rectangle, the ratio of the bounding box area to the soft macro area will be 1.0 and no penalty will be applied. A convoluted shape of the soft macro may cause the bounding box to cover a large area in order to contain all the components of the soft macro and may result in a ratio that is greater than 1.0. Should the ratio satisfy threshold, a penalty will be applied. The resulting ratio value is an argument to a penalty function a 4 and is used as a part of the optimization equation, as set forth below:
shaper_function=a₁(penalty_{utilization}*utilization_ratio)+a₂ (target_shape_deviation)+a₃ (perimeter_ratio)+a₄ (area_ratio)

As depicted by step 145, the shaper function may include an aspect ratio penalty. The aspect ratio of a current soft macro may be used as a constraint. The aspect ratio of a current soft macro can be calculated based on the bounding box of the soft macro. In one embodiment, the aspect ratio is the ratio of the current soft macro width to the current soft macro height. Moreover, the maximum or minimum of the width of the bounding box may also be defined as a constraint. Likewise, the maximum or minimum of the height of the bounding box also may be defined as a constraint. For rectangular soft macros, the aspect ratio may be enforced in the optimization process, as described below:

$$aspect\_ratio = \frac{width}{height}$$

An aspect ratio for non-rectangular soft macros may be used in the optimization process. As described below, two aspect ratios may represent the non-rectangular soft macros. These aspect ratios compare the area of the current soft macro and the width and height of the corresponding bounding box surrounding the current soft macro. Aspect ratio₁ represents the ratio of the width of the bounding box, squared, to the area of the current soft macro. Aspect ratio₂ represents the ratio of the area of the placed soft macro to the height of the bounding box, squared, as described below:

$${aspect\_ratio}_{1} = \frac{{width}^{2}}{area}$$

$${aspect\_ratio}_{2} = \frac{area}{{height}^{2}}$$

Moreover, minimum or maximum values for the aspect ratio can be defined as constraints. For example the minimum aspect ratio may be constrained to be 0.5 while a maximum aspect ratio might also be specified with a constraint value of 2.0. For non-rectangular soft macros, the aspect ratio definition that may be used in the shaper equation may depend on the nature of the constraint, as described below.

$${aspect\_ratio}_{1} = \frac{{width}^{2}}{area} \leq maximum\_constraint \_value$$

$${aspect\_ratio}_{2} = \frac{area}{{height}^{2}} \geq minimum\_constraint \_value$$

The aspect ratio is multiplied by penalty_{aspect} which is a normalization term. The product is an argument to a penalty function a₅, as set forth below:
shaper_function=a₁(penalty_{utilization}*utilization_ratio)+a₂ (target_shape_deviation)+a₃ (perimeter_ratio)+a₄ (area_ratio)+a₅ (penalty_{aspect}*aspect_ratio)

In one embodiment, the shaper function also includes placement correlation which is considered during soft macro shape optimization. Placement correlation includes two components in the shaper function, a displacement penalty and a coverage ratio penalty depicted by steps 146 and 147, respectively. The displacement penalty is factored into the shaper function where the movement or displacement of the current soft macro from the center of gravity of the rough global placement satisfies a threshold amount. The displacement penalty seeks to minimize the total displacement of the soft macro from the rough global placement location. Should the displacement satisfy a threshold, which may in fact be zero, a penalty will be applied, where the resulting displacement value is an argument to a penalty function a₆ and is used as a part of the optimization equation, as set forth below:
shaper_function=a₁(penalty_{utilization}*utilization_ratio)+a₂ (target_shape_deviation)+a₃ (perimeter_ratio)+a₄ (area_ratio)+a₁(penalty_{aspect}*aspect_ratio)+a₆ (displacement)

The coverage ratio penalty seeks to shape a soft macro outline to match the placement of the hard macros and/or standard cells which are included in the soft macro. In one embodiment, the coverage ratio is determined by determining how much of a current soft macro shape overlaps with the shape of the global or previous soft macro outline shape and dividing this overlap by the total cell area of the soft macro. Should the ratio satisfy a threshold, which may in fact be zero, a penalty will be applied. The ratio value is an argument to a penalty function a 7 and is used as a part of the optimization equation, as set forth below:
shaper_function=a₁(penalty_{utilization}*utilization_ratio)+a₂ (target_shape_deviation) a₃ (perimeter_ratio)+a₄ (area_ratio)+a₅ (penalty_{aspect}*aspect_ratio)+a₆ (displacement)+a₇(coverage_ratio)

As depicted by step 148, the shaper function may include one or any combination of a grid, relative placement, and repeated block penalties which are described below. A grid that aids in defining the chip layout and the placement of objects on the grid may be used as a constraint. A constraint may be that a corner of the current soft macro outline be aligned with any grid location. Where the difference in alignment is beyond a threshold, a grid penalty may be enforced. This type of constraint may be used to ensure the soft macro is not placed outside of the grid. A further constraint could be that the current soft macro be aligned with a specific grid location. One skilled in the art will recognize the possibility of various other constraints involving a grid.

In one embodiment, the shaper function includes a relative placement penalty. A distance between a current placement of a first circuit component and a current placement of a second circuit component may be calculated, where the circuit components are soft macros, hard macros, and/or standard cells. In one embodiment, the distance is measured between a specific point on each component. In the event this distance satisfies a threshold, a relative penalty may be enforced by executing a penalty function with the distance as an argument. For example, a constraint specifying a penalty for distances between macro shapes which satisfies a threshold may be applied. A distance can be specified as being between two soft macros, two hard macros, a soft macro and a hard macro, or any combination thereof. The distance may be helpful in defining a channel for wiring metallization on the chip. Other relative placement constraints can be specified. For example, relative placement constraints can be specified for a soft macro or a hard macro relative to a chip edge, as well as between different macros.

In one embodiment, the shaper function includes one or more repeated block constraints. A repeated block is defined to be a soft macro with multiple instances where each instance provides the same logic functionality as is intended to share the same physical implementation. In the case of a repeated block, each instance's outline shape should be identical. A firm requirement can be specified requiring all copies of the repeated block to have identical outline shapes. Alternatively, a constraint, rather than a requirement, can specify that outline shapes of all instances of the repeated block be identical. The repeated block constraint indicates that all the soft macro outlines are to be optimized to have the same shape. Differing shapes may be allowed, but penalty functions are used to drive the shapes to be similar if not identical. Further, a mirror or rotation can be specified for a repeated block's outline shape, resulting in the outline shape to be similar but with a different orientation.

The preceding discussion of the shaper function has been in the context of optimizing soft macro shaping and placement. Hard macros existing at the top level design may also be optimized using the methods described herein. For top level designs including hard macros, a soft macro can be envisioned to bound the hard macro. However, the hard macro's defined aspect ratio, width, and height are requirements rather than constraints considered for optimization. As indicated earlier, constraints are not hard requirements but are rather points of optimization. If a constraint is not met, a violation is said to occur. If a requirement is not met, the placement is invalid. The soft macros apparently surrounding the top level hard macros may be placed following the same approach described herein.

As depicted by step 149A, the shaper function for the soft macro is calculated. In one embodiment, the calculation is a sum of the penalties for the enforced constraints. As depicted by step 149B, it is determined whether all soft macros in the placement which are subject to optimization are accounted for as having a calculated shaper function. As previously described, the shaper function is determined for each soft macro that is to be optimized within the circuit design. The process is iterative until all shaper functions have been calculated. As depicted by step 149C, the total shaper function is then calculated. The total shaper function is an overall cost of the soft macros within the circuit design and is the weighted summation of all the shaper functions which evaluate various constraints for the soft macros being optimized. In one embodiment, the weighting factor is applied to each of the soft macros being optimized, as described below:

$$Total\_shaper \_function = {\sum }_{all\_soft \_macros} {ϖ}_{s} * {shaper\_function}_{ s}$$

Referring back to FIG. 1A, at step 140, shaping and placement of the soft macros are performed. The previous discussion with regard to FIG. 1B has been in the context of measuring the cost associated with the soft macros. A configuration of a current placement is optimized to produce a subsequent placement by minimizing the cost associated with the current placement configuration. As previously mentioned, the total shaper function represents the cost of the current placement configuration. The optimization process seeks to minimize the cost (e.g., total shaper function) with each subsequent placement using optimization methods which are well understood in this art. Thus, it can be said that the total shaper function simultaneously optimizes the shape and placement for all of the soft macros across the chip. In one embodiment, any combination of the preceding penalties may be used in the shaper function for soft macro optimization. In another embodiment, the aforementioned constraints may be used in conjunction with other constraints. In yet another embodiment, a user may define constraints to be placed on the soft macros. The violation of the user-defined constraints may include penalties. The penalties of the user-defined constraints may be factored into the optimization equation. Moreover, all or a subset of the soft macros of a chip design may be optimized.

At step 150, the hard macros are placed in a subsequent placement. A subsequent placement of a hard macro is one which has been optimized within an iteration of the recursive process of FIG. 1A. The placement is optimized considering placement correlation and other factors such as overlaps, connectivity between the macros and wiring congestion. Placement correlation consists of movement or displacement of the current hard macro's center of gravity from the hard macro's center of gravity during rough global placement. A smaller placement correlation number indicates a smaller displacement. The optimization objective is to minimize the displacement by keeping the placement correlation number small.

At step 160, it is determined whether the hard macros at the top level are legalized. For example, if there is any overlap between hard macros, they fail the legalization test. Furthermore, the system checks that the hard macros which are part of a soft macro are legalized. These hard macros are legalized if they reside entirely within the soft macro outline. If these checks have been met, legalization of the design process is complete and processing ends. If any one of the checks has not been met, processing continues to step 170.

At step 170, the soft macro shapes are updated as needed. For example, the update can involve the enlargement of target outlines for the soft macros containing hard macros that failed the legalization test, in order to guide subsequent optimization to assign larger area for these soft macros. After the soft macro shapes are updated processing continues to step 120 to recursively determine the area and utilization for each soft macro. Processing continues to repeat until a valid placement is found, the reduction in cost associated with subsequent placements is diminishing, or if a maximum number of iterations is performed. In one embodiment, the updated soft macro shapes determined in step 170 are the target outlines and placements of step 130 in a subsequent iteration. Those soft macros not updated by step 170 have target outlines and placements of step 130 constructed during subsequent passes. In one embodiment, the penalty function is modified for each subsequent pass to force the optimization process to choose soft macro shapes very close or the same as those chosen during step 170. Ultimately, placement may be valid if the total shaper function satisfies a threshold penalty value. A final placement is a last placement during the layout and placement procedure of integrated circuit design.

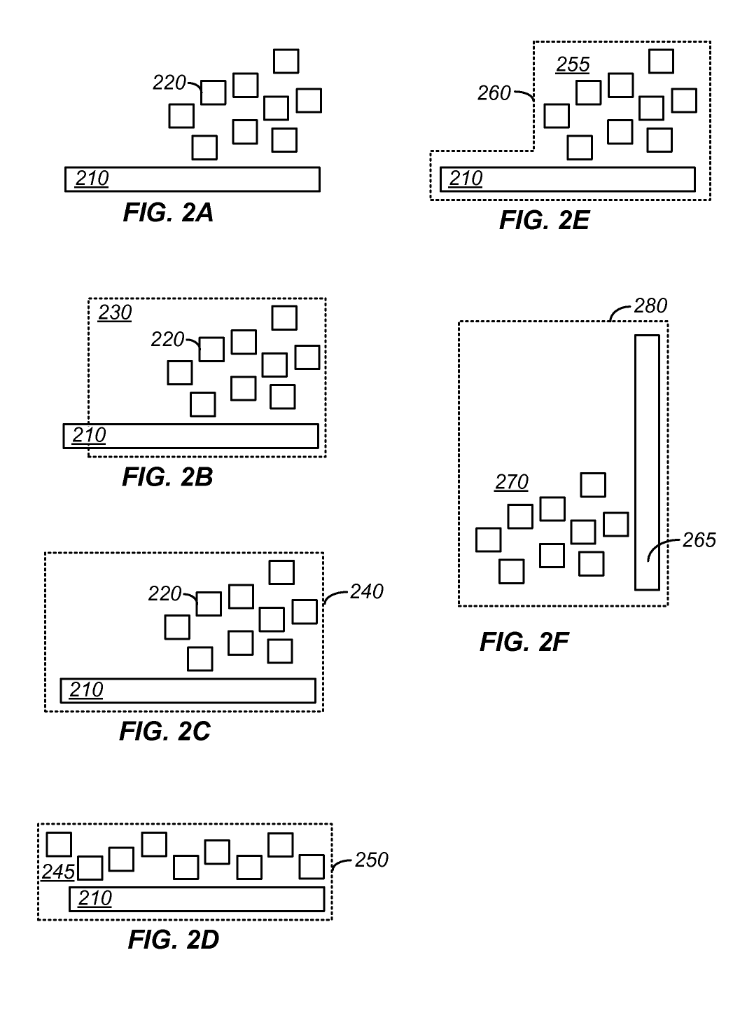

FIGS. 2A-2F, 3A-3B, 4A-4D, 5A-5B, 6A-6B, and 7A-7B are exemplary diagrams provided to illustrate various features and characteristics of the processes depicted by FIGS. 1A-1B, and as such are not intended to be limiting.

FIGS. 2A-2F illustrate possible soft macro shapes. FIG. 2A is a diagrammatic representation of a possible soft macro configuration. As depicted, a soft macro is comprised of a hard macro 210 and standard cells 220.

FIG. 2B is a diagrammatic representation of an invalid soft macro outline. The soft macro of FIG. 2A comprising hard macro 210 and standard cells 220 is depicted along with a soft macro outline 230. The soft macro outline 230 does not encompass the entire hard macro 210. Accordingly, the soft macro shape 230 fails a legalization requirement, such as that described at step 160 of FIG. 1A.

FIG. 2C is a diagrammatic representation of a valid soft macro outline. The soft macro of FIG. 2A comprising hard macro 210 and standard cells 220 is depicted along with a soft macro outline 240. The soft macro outline 240 encompasses the entire hard macro 210. Accordingly, the soft macro outline 240 is acceptable for passing a legalization requirement, such as that described at step 160 of FIG. 1A.

FIG. 2D is a diagrammatic representation of an optimal soft macro configuration. A soft macro comprising hard macro 210 and standard cells 245 is depicted along with a soft macro outline 250. In this embodiment, the perimeter ratio between the soft macro outline 250 and the perimeter of bounding box is nearly 1.0. Accordingly, a perimeter ratio penalty may not be enforced on the soft macro using the shaper function, as described at step 143 of FIG. 1B. Moreover, the area ratio between the actual area occupied by the soft macro outline 250 and the area occupied by bounding box is nearly 1.0. Accordingly, an area ratio penalty may not be enforced on the soft macro using the shaper function, as described at step 144 of FIG. 1B.

FIG. 2E is a diagrammatic representation of a soft macro configuration with an L-shaped outline. The soft macro comprising hard macro 210 and standard cells 255 is depicted along with an L-shaped soft macro outline 260. The soft macro is optimized to be a simple shape, such as a rectangle. In this embodiment, however, the target outline 260 is an “L” shape. The “L” shape may be considered a simple shape, however a rectangle or square shape is generally considered to be more efficient.

Lastly, FIG. 2F is another diagrammatic representation of a possible soft macro configuration. The soft macro comprising hard macro 265 and standard cells 270 is depicted along with a soft macro outline 280. In this embodiment, the hard macro 265 represents a 90 degree rotation of 210 in FIG. 2E. Prior art optimization methods have allowed the directional orientation of a hard macro to be changed. The limitations of prior optimization methods are exemplified by this figure. For example, an L-shaped soft macro outline may be more useful than outline 280.

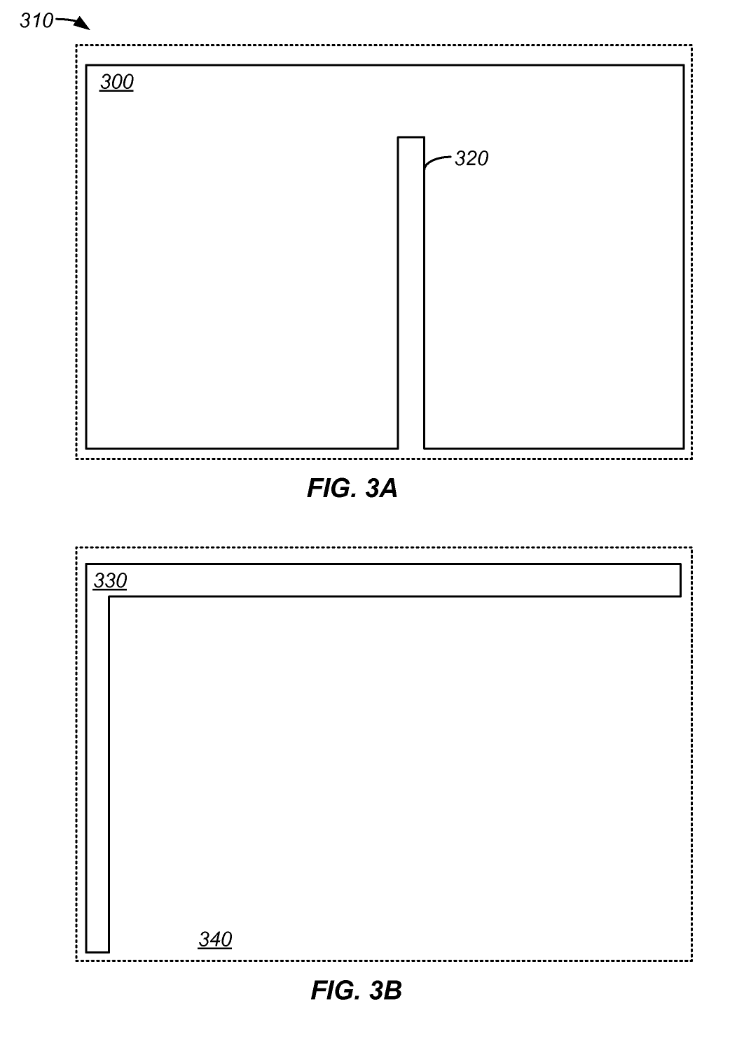

FIG. 3A is a diagrammatic representation of a notch-shaped soft macro and an accompanying bounding box. Although the area utilization of 300 compared to the bounding box 310 is very close to 1.0, the perimeter ratio is not optimal. Soft macro designs may be optimized to drive the ratio between the perimeter of a placed soft macro to the perimeter of a bounding box closest to 1.0. Notch 320 causes the soft macro 300 perimeter to be quite large. In this embodiment, the bounding box perimeter 310 is smaller than the soft macro 300 perimeter. Accordingly, the perimeter ratio is more than 1.0. A perimeter ratio penalty may be enforced if the ratio satisfies a threshold. In one embodiment, this optimization would cause the soft macro outline to have a more simple shape.

FIG. 3B is a diagrammatic representation of an “L-shaped” soft macro and an accompanying bounding box. Soft macro shapes may be optimized to drive the ratio between the area of the bounding box to the area of the corresponding placed soft macro closer to 1.0. In this embodiment, the area occupied by the bounding box 340 is significantly greater than the area of soft macro 330. Accordingly, the area ratio is more than 1.0. An area ratio penalty may be enforced if the ratio satisfies a threshold. In one embodiment, this optimization will cause the soft macro outline to have a more simple shape.

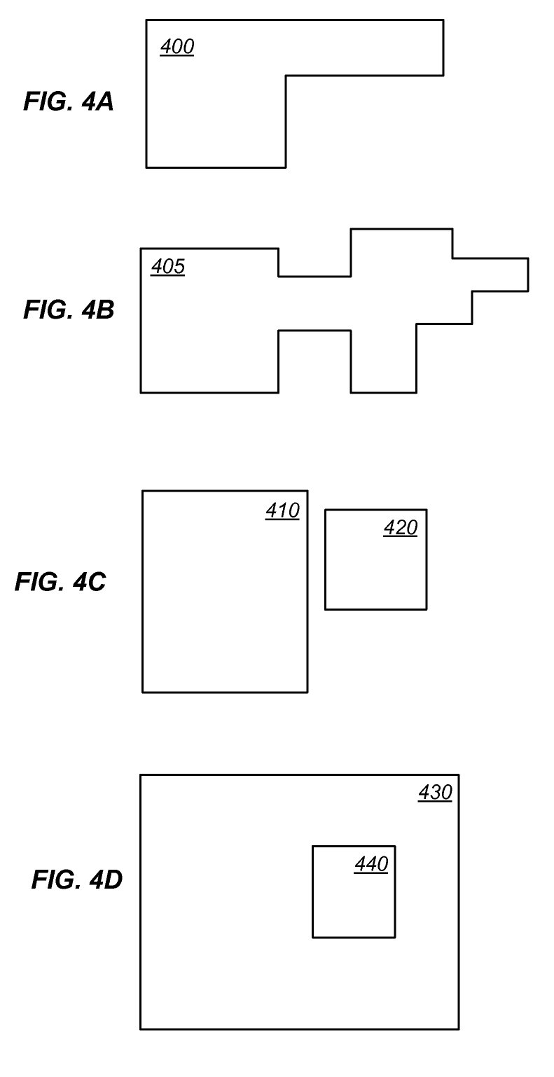

FIGS. 4A-4D are diagrammatic representations of soft macro outlines illustrating shapes. FIG. 4A is a diagrammatic representation of an L-shaped soft macro. As shown, soft macro outline 400 has an “L” shape. Rectangular shapes are considered to be the simplest of shapes, whereas “L” shapes are considered to be slightly more complex simple shapes.

FIG. 4B is a diagrammatic representation of a soft macro having a non-simple shape. In this embodiment, the soft macro outline 405 is non-simple in shape because the shape is neither rectangular nor L-shaped and has more than the threshold number of sides. The soft macro outline 405 has eighteen sides, whereas soft macro outline 400 of FIG. 4A has six sides. In one embodiment, soft macro outline 405 is a macro with a valid but less than optimal shape.

FIG. 4C is a diagrammatic representation of an invalid soft macro configuration. As illustrated, the soft macro is broken into two pieces, a first piece 410 and a second piece 420. Requirements, rather than constraints considered for optimization, may be set, for example, by a user. In one embodiment, a requirement is set which invalidates any soft macro configuration including multiple separate pieces for a single soft macro. Accordingly, the soft macro shaping and placement as depicted is not valid.

FIG. 4D is a diagrammatic representation of another invalid soft macro configuration. A soft macro outline 430 is depicted along with a hole 440 within the soft macro. Requirements rather than constraints considered for optimization may be set, for example, by a user. In one embodiment, a requirement is set which invalidates any soft macro configuration including a hole or donut shape within the soft macro outline. Accordingly, the soft macro outline 430 is an invalid configuration.

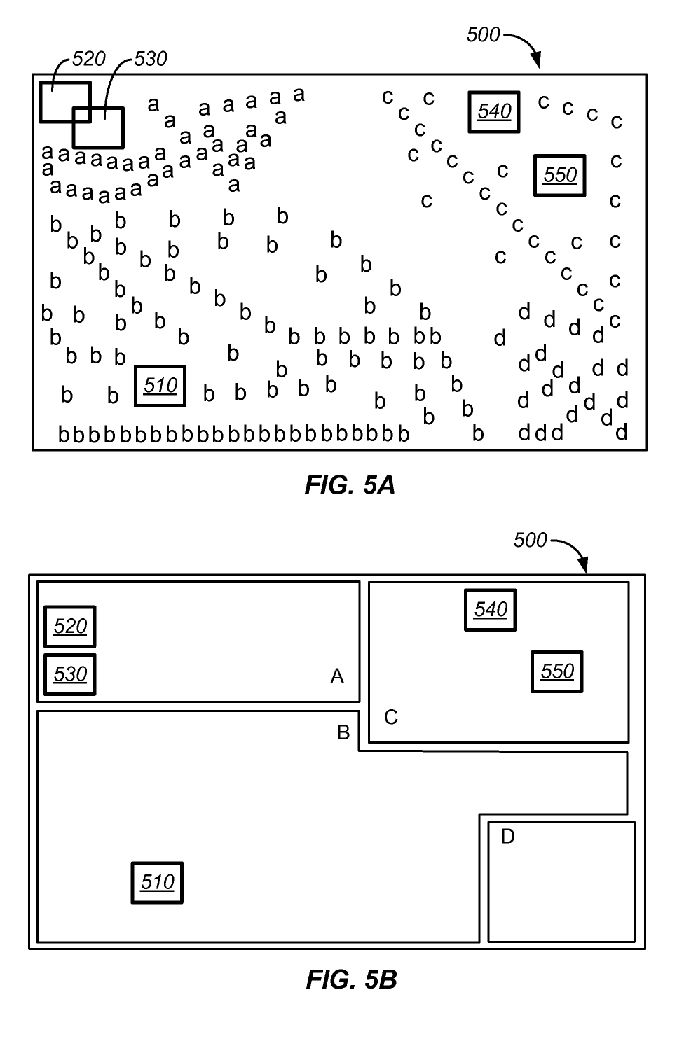

FIG. 5A is a diagrammatic representation of a chip design with standard cells and hard macros after rough global placement. Hard macros 510, 520, 530, 540, and 550 are placed during rough global placement within chip area 500. Hard macros 520 and 530 overlap with each other. Overlap is permitted during rough global placement. Standard cells “a”, “b”, “c”, and “d” are also placed within chip area 500. The standard cells “a”, “b”, c and “d” include four different soft macros, for example soft macros “A”, “B”, “C”, and “D”, respectively.

FIG. 5B is a diagrammatic representations of a chip design with soft macros and the standard cells and hard macros contained within the soft macros after final placement. The methodology as described herein receives the rough global placement of FIG. 5A. After iteratively applying the methodology as described herein, the final placement is produced. In this embodiment, the soft macro A contains all of the individual standard cells “a” of FIG. 5A. Furthermore, the soft macro A also includes hard macros 520 and 530. Likewise, soft macro B contains all of the individual standard cells “b” of FIG. 5A and hard macro 510. Soft macro C contains all of the individual standard cells “c” of FIG. 5A in addition to hard macros 540 and 550. Lastly, soft macro D contains all of the individual standard cells “d” of FIG. 5A. In this embodiment, each of the soft macros A-D have been optimized. The shapes of the soft macros have been optimized to produce simple shapes. Soft macros A, C, and D are all rectangular in shape. The hard macros 520 and 530 have been legalized to correct the overlap present in FIG. 5A. In one embodiment, other optimizations may have been performed to produce the final placement.

Penalty functions may be applied during optimization of various constraints. A user may select a penalty function to be applied to a constraint. In an alternative embodiment, the penalty function is selected by the system. Penalty functions may be selected for each constraint and may be based on how aggressively the constraint should be optimized. A critical constraint may be highly optimized, meaning an aggressive penalty function will be paired with the constraint. A less-than-critical constraint may be moderately optimized. It should be recognized that other levels of optimization may be implemented without departing from the scope of the teachings herein.

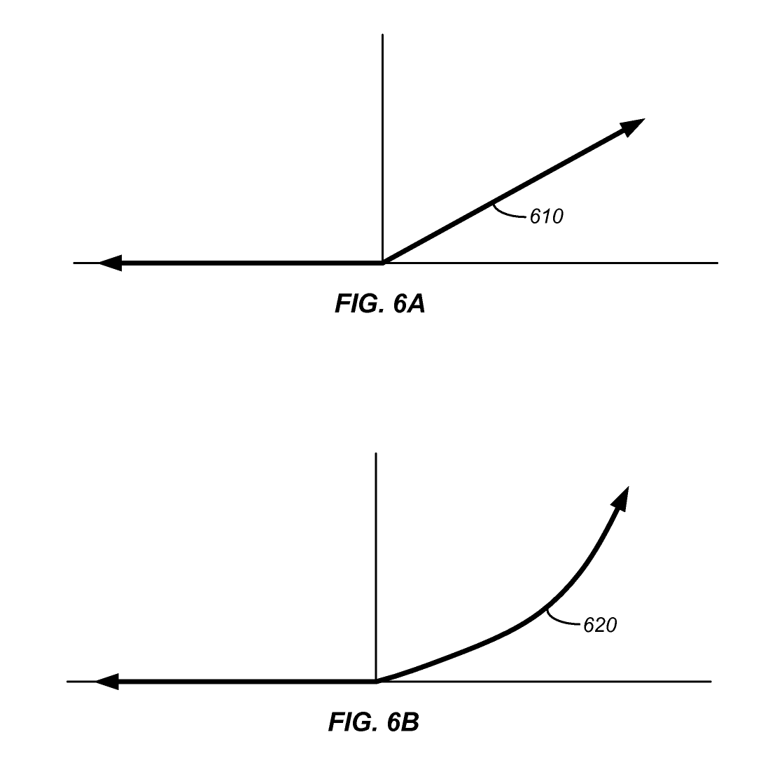

FIG. 6A is a graphic representation of a linear growth penalty function applied during optimization of a constraint. In one embodiment, the penalty is enforced as a linearly growing penalty function 610. This type of penalty function may be employed for less-than-critical constraints. For example, a utilization penalty may be deemed a less-than-critical constraint. In one embodiment, the X-axis represents an argument to the penalty function such as a utilization violation, which may be defined as a current utilization minus a target utilization. The Y-axis represents a penalty value. As shown, where the utilization violation is negative, meaning the current utilization is less than the target utilization, no penalty will be enforced. Where the utilization violation is positive, the linear growth penalty function will be enforced based on the value of the utilization violation. A higher utilization violation corresponds to a higher penalty value to be applied to the constraint. Alternatively, a penalty function may also be applied for negative values, such that the penalty function would be mirrored about the Y-axis, producing a V-shaped penalty function. In another embodiment, the X-axis may represent a ratio value, or a relational value, such as deviation or displacement. As shown, the threshold value for applying the penalty is at zero. However, it should be recognized that the threshold value may be shifted anywhere along the X-axis.

FIG. 6B is a graphic representation of an exponential growth penalty function applied during optimization of a constraint. An exponentially growing penalty function 620 may be applied to optimize critical constraints. For example, a perimeter penalty may be deemed of critical importance for which the objective of the penalty function is to optimize the ratio to obtain a value closest to one. In another embodiment, the penalty functions are employed with the objective of optimizing the constraint to obtain the smallest value possible, for example, when optimizing for specific utilization values, shape deviation, displacement, and other relative measurements.

In one embodiment, the X-axis represents a perimeter ratio value, which may be defined as the perimeter of the soft macro divided by the perimeter of the bounding box. The Y-axis represents a penalty value. Alternatively, a penalty function may also be applied for negative values, such that the penalty function would be mirrored about the Y-axis, producing a U-shaped penalty function. In another embodiment, the X-axis may represent a violation result, or a relational value, such as deviation or displacement. A higher ratio value corresponds to an exponentially higher penalty value. As shown, the threshold value for applying the penalty is at zero. However, it should be recognized that the threshold value may be shifted anywhere along the X-axis. For example, a threshold for applying the perimeter penalty could be set at 1.0. In another embodiment, the threshold may be set at 1.5, which would permit the perimeter of the soft macro to be larger than the perimeter of the bounding box.

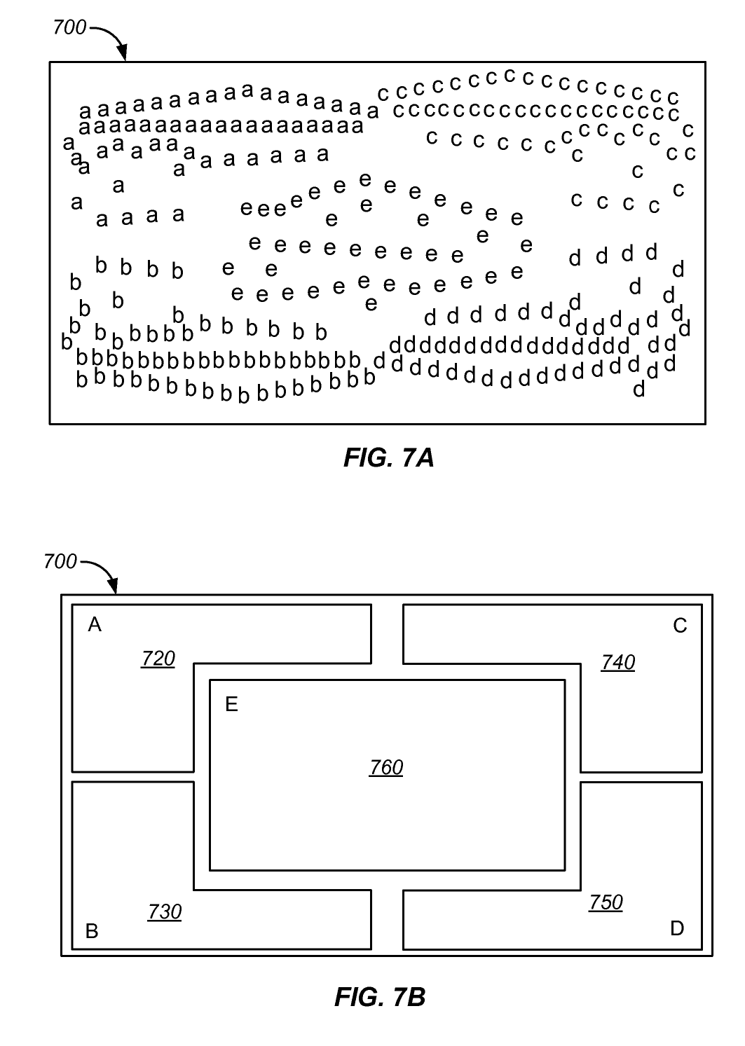

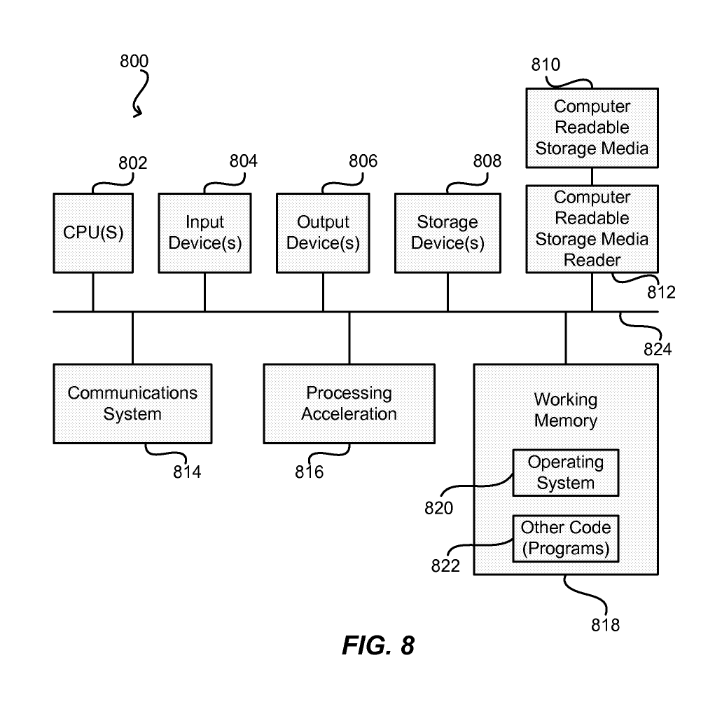

FIG. 7A is a diagrammatic representation of standard cells comprising soft macros after rough global placement. In one embodiment, standard cells “a”, “b”, “c”, and “d” are placed within chip area 700 after a rough global placement. The standard cells “a”, “b”, “c”, and “d” include four repeated soft macros, for example soft macros “A”, “B”, “C”, and “D”, respectively. The repeated soft macros are mirrored about the X axis. For example, the standard cells “a” included in soft macro A mirror standard cells “b” included in soft macro B about the X axis.

FIG. 7B is a diagrammatic representation of standard cells included in soft macros after final placement. The final soft macro placements of soft macro A 720, soft macro B 730, soft macro C 740, and soft macro D 750 are similar or even identical in shape but with different orientations. Soft macro E 760 is not a repeated soft macro and contains all of the “e” standard cells.

FIG. 8 illustrates an exemplary computer system 800, in which various embodiments of the present invention may be implemented. The system 800 may be used to implement any of the computer systems described above. The computer system 800 is shown comprising hardware elements that may be electrically coupled via a bus 824. The hardware elements may include one or more central processing units (CPUs) 802, one or more input devices 804 (e.g., a mouse, a keyboard, etc.), and one or more output devices 806 (e.g., a display device, a printer, etc.). The computer system 800 may also include one or more storage devices 808. By way of example, the storage device(s) 808 can include devices such as disk drives, optical storage devices, solid-state storage device such as a random access memory (“RAM”) and/or a read-only memory (“ROM”), which can be programmable, flash-updateable and/or the like.

The computer system 800 may additionally include a computer-readable storage media reader 812, a communications system 814 (e.g., a modem, a network card (wireless or wired), an infra-red communication device, etc.), and working memory 818, which may include RAM and ROM devices as described above. In some embodiments, the computer system 800 may also include a processing acceleration unit 816, which can include a digital signal processor DSP, a special-purpose processor, and/or the like.

The computer-readable storage media reader 812 can further be connected to a computer-readable storage medium 810, together (and, optionally, in combination with storage device(s) 808) comprehensively representing remote, local, fixed, and/or removable storage devices plus storage media for temporarily and/or more permanently containing computer-readable information. The communications system 814 may permit data to be exchanged with the network and/or any other computer described above with respect to the system 800.

The computer system 800 may also comprise software elements, shown as being currently located within a working memory 818, including an operating system 820 and/or other code 822, such as an application program (which may be a client application, Web browser, mid-tier application, RDBMS, etc.). It should be appreciated that alternate embodiments of a computer system 800 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims. In addition, the technique and system of the present invention is suitable for use with a wide variety of EDA tools and methodologies for programming a device. The scope of the invention should, therefore, be determined not with reference to the above description, but instead should be determined with reference to the pending claims along with their full scope or equivalents.

Although the present invention has been described in detail with regarding the exemplary embodiments and drawings thereof, it should be apparent to those skilled in the art that various adaptations and modifications of the present invention may be accomplished without departing from the spirit and the scope of the invention. Thus, by way of example and not of limitation, the present invention is discussed as illustrated by the figures. Accordingly, the invention is not limited to the precise embodiment shown in the drawings and described in detail herein above.

What is claimed is:

1. An electronic design automation method of placing circuit components of an integrated circuit (“IC”), the method comprising:
receiving a synthesized circuit netlist comprising one or more soft macros;
performing a rough global placement of the netlist;
determining a shaper function to evaluate a cost of a current placement of the one or more soft macros based on one or more constraints and one or more penalty functions associated with the one or more constraints;
optimizing the current placement to produce a subsequent placement of the one or more soft macros by minimizing the cost; and
where the netlist includes one or more hard macros, applying a legalization requirement to the one or more hard macros.

2. The method of claim 1, wherein the legalization requirement prevents overlap between the one or more hard macros.

3. The method of claim 1, wherein a hard macro of the one or more hard macros is incorporated in a soft macro of the one or more soft macros.

4. The method of claim 3, wherein the legalization requirement prevents any portion of the hard macro to be placed beyond an outline of the soft macro.

5. Where the shaper function is based on a utilization constraint of the one or more constraints, the method of claim 1, further comprising:
determining a target utilization corresponding to each soft macro of the one or more soft macros to represent a target density of soft macro components.

6. The method of claim 5, wherein determining the shaper function further comprises:
calculating a utilization ratio by determining a difference between a current utilization of a current soft macro of the one or more soft macros and the corresponding target utilization;
in the event the difference satisfies a threshold, normalizing the utilization ratio; and
calculating a utilization penalty by executing a penalty function with the normalized utilization ratio as an argument.

7. Where the shaper function is based on a shape deviation constraint of the one or more constraints, the method of claim 1, further comprising:
constructing a target outline corresponding to each soft macro of the one or more soft macros.

8. The method of claim 7, wherein determining the shaper function further comprises:
calculating a difference between a shape of a current soft macro of the one or more soft macros and the corresponding target outline; and
in the event the difference satisfies a threshold, calculating a shape deviation penalty by executing a penalty function with the difference as an argument.

9. Where the shaper function is based on a perimeter constraint of the one or more constraints, the method of claim 1, wherein determining the shaper function further comprises:
calculating a ratio of a perimeter of a current soft macro of the one or more soft macros to a perimeter of a bounding box; and
in the event the ratio satisfies a threshold, calculating a perimeter penalty by executing a penalty function with the ratio as an argument.

10. Where the shaper function is based on an area constraint of the one or more constraints, the method of claim 1, wherein determining the shaper function further comprises:
calculating a ratio of an area of a bounding box to an area of a current soft macro of the one or more soft macros; and
in the event the ratio satisfies a threshold, calculating an area penalty by executing a penalty function with the ratio as an argument.

11. Where the shaper function is based on the aspect constraint of the one or more constraints, the method of claim 1, wherein determining the shaper function further comprises:
calculating an aspect ratio based on a bounding box and an area of a current soft macro of the one or more soft macros;
normalizing the aspect ratio; and
calculating an aspect penalty by executing a penalty function with the normalized aspect ratio as an argument.

12. Where the shaper function is based on a displacement constraint of the one or more constraints, the method of claim 1, wherein determining the shaper function further comprises:
calculating a difference between a rough global placement of a soft macro of the one or more soft macros and a current placement of the soft macro; and
in the event the difference satisfies a threshold, calculating a displacement penalty by executing a penalty function with the difference as an argument.

13. Where the shaper function is based on a coverage constraint of the one or more constraints, the method of claim 1, wherein determining the shaper function further comprises:
determining an overlap shape between a shape of a current soft macro of the one or more soft macros and a shape of a previous soft macro; and
in the event the overlap shape satisfies a threshold, calculating a coverage penalty by executing a penalty function with the overlap shape as an argument.

14. Where the shaper function is based on a grid constraint of the one or more constraints, the method of claim 1, wherein determining the shaper function further comprises:
calculating a difference between a current alignment of a soft macro of the one or more soft macros on a grid to a target grid location; and
in the event the difference satisfies a threshold, calculating a grid penalty by executing a penalty function with the difference as an argument.

15. Where the shaper function is based on a relative constraint of the one or more constraints, the method of claim 1, wherein determining the shaper function further comprises:
calculating a distance between a current placement of a first circuit component and a current placement of a second circuit component; and
in the event the distance satisfies a threshold, calculating a relative penalty by executing a penalty function with the distance as an argument.

16. Where the shaper function is based on a repeated block constraint of the one or more constraints, the method of claim 1, wherein determining the shaper function further comprises:
calculating a difference between a shape of a first instance of a soft macro of the one or more soft macros and a shape of a second instance of the soft macro; and
in the event the difference satisfies a threshold, calculating a repeated block penalty by executing a penalty function with the difference as an argument.

17. The method of claim 1, wherein the determining, optimizing, and applying are recursively repeated until a valid placement is found.

18. The method of claim 1, further comprising:
after optimizing, determining a subsequent placement of the one or more hard macros.

19. The method of claim 1, further comprising:
after performing the rough global placement, determining an area available for a subsequent placement for each soft macro of the one or more soft macros.

20. An electronic design automation method of placing hard macros and soft macros in an integrated circuit (“IC”), the method comprising:
determining an area available for an optimized placement of the soft macros;
determining a target utilization for each of the soft macros to represent a target density of soft macro components;
constructing a target outline for each of the soft macros;
determining a cost of a current placement of the soft macros based on a plurality of constraints and associated penalty functions;
determining the optimized placement of the soft macros by minimizing the cost of the current placement;
determining an optimized placement of the hard macros;
determining if the hard macros are legalized; and
updating the target outline of the soft macros comprising hard macros that are not legalized.

21. The method of claim 20, wherein determining the optimized placement of the hard macros comprises checking the optimized placement of the hard macros for overlap.

22. The method of claim 20, wherein determining the optimized placement of the hard macros comprises checking the optimized placement of the soft macros for a hard macro that does not reside entirely within a single soft macro.

23. A computer program product embedded in a computer-readable medium for placement of macros, the computer program product comprising:
code for receiving a synthesized circuit netlist comprising one or more soft macros;
code for performing a rough global placement of the netlist;
code for determining a shaper function to evaluate a cost of a current placement of the one or more soft macros based on one or more constraints and one or more penalty functions associated with the one or more constraints;
code for optimizing the current placement to produce a subsequent placement of the one or more soft macros by minimizing the cost; and
code for applying a legalization requirement to the one or more hard macros where the netlist includes one or more hard macros.

24. Where the shaper function is based on a shape deviation constraint of the one or more constraints, the computer program product of claim 23 further comprising:
code for constructing a target outline corresponding to each soft macro of the one or more soft macros.

25. The computer program product of claim 24, wherein determining the shaper function further comprises:
code for calculating a difference between a shape of a current soft macro of the one or more soft macros and the corresponding target outline; and
in the event the difference satisfies a threshold, code for calculating a shape deviation penalty by executing a penalty function with the difference as an argument.

26. Where the shaper function is based on a perimeter constraint of the one or more constraints, the computer program product of claim 23, wherein determining the shaper function further comprises:
code for calculating a ratio of a perimeter of a current soft macro of the one or more soft macros to a perimeter of a bounding box; and
in the event the ratio satisfies a threshold, code for calculating a perimeter penalty by executing a penalty function with the ratio as an argument.

27. Where the shaper function is based on an area constraint of the one or more constraints, the computer program product of claim 23, wherein determining the shaper function further comprises:
code for calculating a ratio of an area of a bounding box to an area of a current soft macro of the one or more soft macros; and
code for in the event the ratio satisfies a threshold, calculating an area penalty by executing a penalty function with the ratio as an argument.

28. Where the shaper function is based on a relative constraint of the one or more constraints, the computer program product of claim 23, wherein determining the shaper function further comprises:
code for calculating a distance between a current placement of a first circuit component and a current placement of a second circuit component; and
in the event the distance satisfies a threshold, code for calculating a relative penalty by executing a penalty function with the distance as an argument.

29. Where the shaper function is based on a repeated block constraint of the one or more constraints, the computer program product of claim 23, wherein determining the shaper function further comprises:
code for calculating a difference between a shape of a first instance of a soft macro of the one or more soft macros and a shape of a second instance of the soft macro; and
in the event the difference satisfies a threshold, code for calculating a repeated block penalty by executing a penalty function with the difference as an argument.

30. A computer program product embedded in a computer-readable medium for placing hard macros and soft macros in an integrated circuit (“IC”), the computer program product comprising:
code for determining an area available for an optimized placement of the soft macros;
code for determining a target utilization for each of the soft macros to represent a target density of soft macro components;
code for constructing a target outline for each of the soft macros;
code for determining a cost of a current placement of the soft macros based on a plurality of constraints and associated penalty functions;
code for determining the optimized placement of the soft macros by minimizing the cost of the current placement;
code for determining an optimized placement of the hard macros;
code for determining if the hard macros are legalized; and
code for updating the target outline of the soft macros comprising hard macros that are not legalized.

31. A data processing system configured to assist a user in the placement of circuit components of an integrated circuit, the data processing system comprising:
a processor coupled to a bus; and
a memory coupled to the bus, the memory configured to store a plurality of code modules which when executed by the processor cause the processor to:
receive a synthesized circuit netlist comprising one or more soft macros;
perform a rough global placement of the netlist;
determine a shaper function to evaluate a cost of a current placement of the one or more soft macros based on one or more constraints and one or more penalty functions associated with the one or more constraints;
optimize the current placement to produce a subsequent placement of the one or more soft macros by minimizing the cost; and
where the netlist includes one or more hard macros, apply a legalization requirement to the one or more hard macros.

32. The data processing system of claim 31 further comprising additional code modules which when executed by the processor cause the processor to:
after the current placement is optimized, determine a subsequent placement of the one or more hard macros.

33. The data processing system of claim 31 further comprising additional code modules which when executed by the processor cause the processor to:
after rough global placement is performed, determine an area available for a subsequent placement for each soft macro of the one or more soft macros.
